(19) United States
(12) Patent Application Publication
(10) Pub. No.: US 2014/0186558 A1
(43) Pub. Date: Jul. 3, 2014

(54) FORM-MEMBER LAMINATED COMPOSITE MATERIALS AND MANUFACTURING METHOD THEREOF

(71) Applicant: Hyundai Motor Company, Seoul (KR)

(72) Inventor: Ho-Seung Lee, Seoul (KR)

(21) Appl. No.: 13/923,987

(22) Filed: Jun. 21, 2013

(30) Foreign Application Priority Data
Dec. 28, 2012 (KR) 10-2012-0155788

(51) Int. Cl. B29C 65/70

(52) U.S. Cl. CPC B29C 65/70
USPC 428/34.1; 264/29.1

(57) ABSTRACT

Disclosed is a composite form-member including: a hollow metal form-member with holes formed through the inner and the outer surface of the form-member; and a coated layer filling the holes and laminated on the inner and outer surfaces of the form-member, the coated layer is made of an organic fiber material with carbon, and a welding portion comprising an exposed outer circumferential surface portion without the coated layer laminated thereon, and a method of manufacturing thereof.

### CROSS-REFERENCE TO RELATED APPLICATION

The present application claims priority to Korean Patent Application No. 10-2012-0155788, filed on Dec. 28, 2012, the entire contents of which is incorporated herein for all purposes by this reference.

### BACKGROUND

(a) Technical Field

The present invention relates to a composite form-member and a manufacturing method thereof, and more particularly, to a form-member having increased hardness and rigidity by being laminated with carbon fiber on a surface thereof. In particular, the composite form-member is composed of a metallic material and a carbon fiber material, and has a surface of one end exposed for welding.

(b) Background Art

Composite materials, which are materials made by physically and/or chemically composing two or more materials, are suitable for various uses in various fields.

For vehicles, composite materials are used for a variety of parts, including not only the vehicle body, but the braking system, the steering system, and electric devices. Use of such composite materials improves fuel efficiency by reducing the weight of the vehicle and further increases safety by improving rigidity.

Generally, the parts made by coating a form-member made of metal with carbon fiber (organic fiber material containing carbon) and/or the parts made of a synthetic resin material or a carbon fiber material are connected by adhesives and/or bolts.

However, since the parts of vehicles are generally welded in most cases because they are made of metal, composite form-members including carbon fiber may limit assembly and mounting of the parts because they cannot be welded.

The description provided above as a related art of the present invention is just for helping understanding the background of the present invention and should not be construed as being included in the related art known by those skilled in the art.

### SUMMARY OF THE DISCLOSURE

The present invention provides a weldable composite form-member (containing carbon fiber) and a method of manufacturing the form-member.

According to one aspect, the present invention provides a composite form-member containing, as reinforcing materials, a weldable metallic material and a carbon fiber material. In particular, the weldable metallic material provides weldability, and the carbon fiber material increases rigidity of the metallic material.

According to various embodiments, the present invention provides a composite form-member including: a hollow (e.g. pipe-shaped) form-member with holes formed through the inner circumference and the outer circumference (i.e. one or more holes formed through the surface of the hollow form member); and a coated layer filling the holes and being laminated on the inner and outer circumferential surfaces of the form-member. According to various embodiments, the form-member is made of metal and the coated layer is made of an organic fiber material with carbon.

According to an exemplary embodiment of the present invention, a welding portion is formed at one end of the form-member. In particular, the welding portion can be an outer circumferential surface portion that is not laminated with the coated layer and, thus, is exposed (i.e. the welding portion, which is formed of metal, is exposed). Further, the form-member is preferably formed in a cylindrical shape and the holes are preferably arranged in rows spaced at predetermined distances around the surface of the form-member.

According to a further aspect, the present invention provides a method of manufacturing a composite form-member, which includes: seating a form-member formed in a hollow shape (e.g. pipe-shape) with holes formed through the inner circumference and the outer circumference, in between an upper die and a lower die, and then inserting a core into the form-member (the core inserted through the hollow of the form-member); ejecting (applying) a powder type of organic fiber material containing carbon together with compressed air through nozzle pipes formed in the upper die, the lower die, and the core, to the inner circumference and the outer circumference of the form-member to fill the holes; and forming a coated layer by heating the organic fiber material ejected on the surface of the form-member from the upper die and the lower die such that the organic fiber material is carbonized.

According to various embodiments, the organic fiber material is partially ejected (or applied) such that the coated layer is not formed at one end portion of the form-member (thus forming the welding portion with the surface of the form-member exposed), and/or the heat is partially applied from the upper die and the lower die.

Other features and aspects of the present invention will be apparent from the following detailed description, drawings and claims.

### BRIEF DESCRIPTION OF THE DRAWINGS

The above and other features of the present invention will now be described in detail with reference to certain exemplary embodiments thereof illustrated the accompanying drawings which are given herein below by way of illustration only, and thus are not limitative of the present invention, and wherein:

FIG. 1 is a view showing a process of machining a plate or a bar into a pipe-shaped form-member by using roll bending or a seamless method, according to an embodiment of the present invention;

FIG. 2 is a view showing that a form-member is inserted in an upper die and a lower die, with a core in the form-member, and a partially enlarged view, according to an embodiment of the present invention;

FIG. 3 is a view showing a process of ejecting powder type (molten) organic fiber with compressed air onto the inner and outer circumferences of the form-member through nozzle pipes formed in the upper die, lower die, and core, according to an embodiment of the present invention;

FIG. 4 is a view showing that the section except for the area A is heated through a high frequency coil when a welding portion is formed, according to an embodiment of the present invention; and

FIG. 5 is a view showing a composite form-member with a coated layer laminated and a welding portion formed at one side, according to an embodiment of the present invention.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, exemplary embodiments of the present invention will be described in detail with reference to the accompanying drawings.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

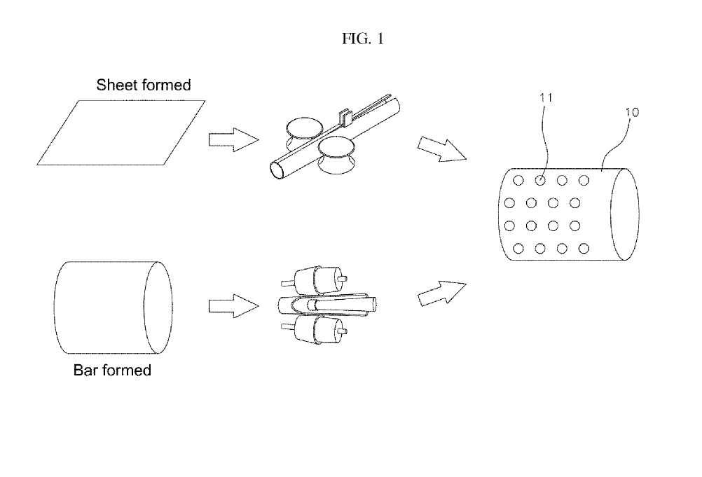

A form-member 10 according to an exemplary embodiment of the present invention is made of weldable metal and is machined into a hollow circular pipe shape from a sheet material or a bar, as shown in FIG. 1. A plurality of holes 11 is formed through the inner and outer circumferences in rows at predetermined distances from each other along the circumference of the form-member 10. It is noted that while a particular number and configuration of holes 11 is depicted in the figures, any other number and arrangement of holes is also within the scope of the present invention. Further, while all of the holes are shown uniform in size, the sizes of the holes can also vary.

The form-member 10 is inserted in between an upper die 20a and a lower die 20b. Further, a high frequency coil 30 or the like, which generates heat from electricity, is positioned therebetween. The space in which the form-member 10 is seated between the upper die 20a and the lower die 20b is formed a little larger than the size of the form-member 10 such that a coated layer 1 (see FIG. 5) can be formed around the outer circumference of the form-member 10. In other words, a gap is provided about the outer circumference of the form-member 10 and the upper and lower die 20a, 20b. The gap is preferably sized such that a powder type or molten organic fiber material can be inserted therein by compressed air or the like.

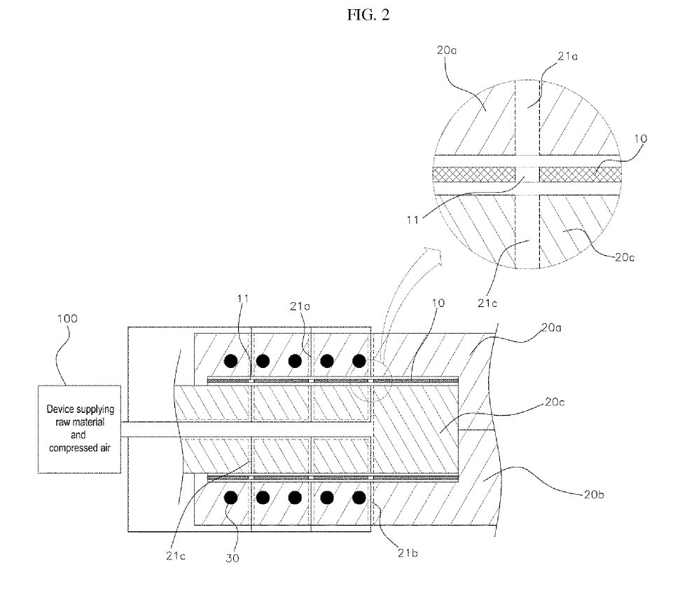

A core 20c is inserted into the form-member 10 which is seated between the upper die 20a and the lower die 20b, as shown in FIG. 2. Similarly, the core 20c is formed to have an outer diameter a little smaller than the hollow within the form-member 10 (i.e. a gap is provided between the inner circumference of the form-member 10 and the core 20c) such that the coated layer 1 can be formed around the inner circumference of the form-member 10 between the outer circumference of the core 20c and the inner circumference of the form-member 10.

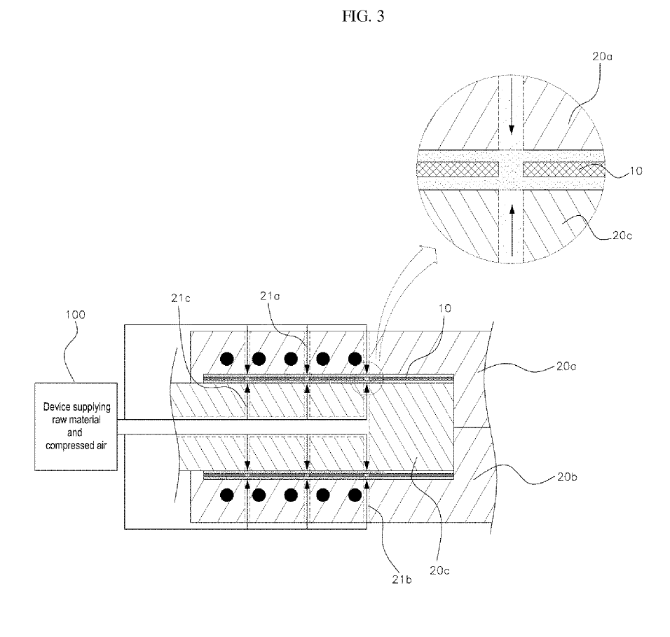

With the upper die 20a and the lower die 20b pressed and closed under a predetermined pressure, fine particles or molten organic fiber materials are ejected towards the inner and outer surfaces of the form-member 10 from a device supplying a raw material. Further, compressed air 100 can be provided through any number of nozzle pipes, for example nozzle pipes 21a, 21b, and 21c which may be disposed at the upper die 20a, the lower die 20b, and the core 20c, respectively (see the arrows in FIG. 3).

As shown in FIG. 3, an organic fiber material containing carbon (in an exemplary embodiment, acryl fiber or flameproof fiber that is an intermediate substance before carbon fiber carbonizes) is ejected, preferably simultaneously, from towards the inside and outside of the form-member 10, such that the holes 11 of the form-member 10 are filled with the organic fiber material. The organic fiber material may be mixed selectively with further materials, such as epoxy-based, phenol-based, and modified resin-based resins, in the ejection process to accelerate hardening in heat treatment.

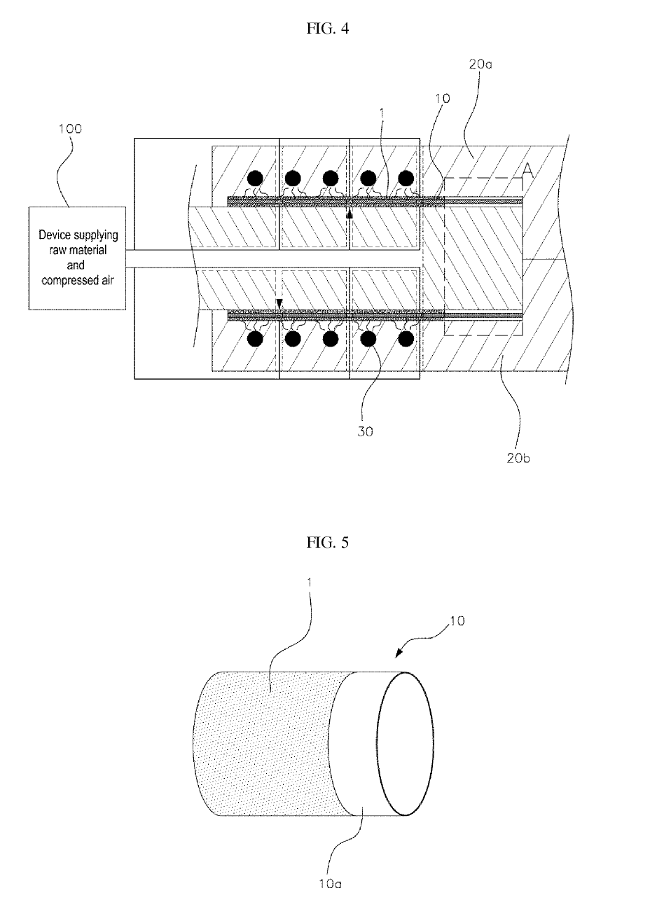

After the organic fiber material is ejected, heat treatment is performed by supplying power to the high frequency coil 30 in the upper die 20a and the lower die 20b such that the organic fiber material applied to the surfaces and holes 11 of the form-member is carbonized, as shown in FIG. 4. In particular, the organic fiber material applied on the form-member 10 is carbonized by heat, thereby forming the coated layer 1.

According to preferred embodiments, one end portion of the form-member is partially coated with the organic fiber material or is partially heated in between the upper die 20a and the lower die 20b so as to provide an exposed portion on which the coated layer 1 is not formed, that is, a welding portion 10a. Thus, the welding potion 10a is a portion having the surface of the form-member exposed without a coated layer 1.

According to an exemplary embodiment, a blocking means (not shown) for preventing penetration of the organic fiber material can be selectively provided in the upper die 20a and the lower die 20b in a location corresponding to the desired welding portion 10a location. According to another exemplary embodiment, the ejection angles or ejection pressures of the nozzle pipes 21a, 21b, and 21c may be controlled so as to prevent formation of the coating layer 1 on the desired welding portion 10a location.

The composite form-member manufactured by the method described above, as shown in FIG. 5, has the coated layer 1 filling the holes 11 of the circular form-member 10 and further being laminated on the inner and outer circumferential surfaces of the form-member 10. Further, the welding portion 10a is formed at one end portion of the form-member 10, with the outer circumferential surface exposed without the coated layer 1. As such, this welding portion 10a is capable of welding.

According to various embodiments, the upper die 20a and the lower die 20b can be mounted and used on common presses with capacities of about 10 to 500 ton. Further, the organic fiber material can be ejected with compressed air at a pressure of about 2 to 7 TON/cm2, with the upper die 20a and the lower die 20b compressed by a press.

According to various embodiments, the nozzle pipes 21a, 21b, and 21c are implemented by a plurality of porous pipes configured for ejecting the organic fiber materials of a fine size to the inside and outside of the form-member 10.

Further, the high frequency coil 30 according to an exemplary embodiment of the present invention has a, capacity of a few hundred KW and can perform heat treatment by outputting a frequency of about 10 KH or less (for example, performs heat treatment at about 200 KW and about 7 kHz frequency). The heat treatment is preferably repeated several times per several seconds˜tens of seconds (for example, repeated about ten times for about 12 seconds each time). The time may be changed, depending on the degree of change of the organic fiber material (e.g. acryl fiber, flameproof fiber, or carbon fiber) and the heat treatment can be performed under a vacuum and/or carbonizable state.

The composite form-member of the present invention manufactured as described above can be attached to a circular internal gear or other peripheral parts by conventional welding techniques, such as electric resistance welding.

The composite form-member according to the present invention can replace many of the metal frame parts of the related art with carbon fiber. As such, the present invention composite form-member can reduce the weight of a vehicle. Further, the composite form-member can be manufactured to have less thickness with an increase in rigidity of the coated layer due to graphitization of the carbon fiber, such that it is possible to reduce the volume. Furthermore, the process of manufacturing carbon fiber, which has been performed in a high-temperature furnace in the related art, is implemented by a high frequency coil in an upper die and a lower die, such that it is possible to reduce the manufacturing cost and the manufacturing time.

The composite form-member of the present invention having the configuration described above can be easily welded to adjacent metal parts or structures due to the welding portion being provided, e.g. protruding, at one side (or both sides). Further, rigidity is improved by the coated layer.

Still further, the coated layer of the present invention is formed on the inner and outer circumferences to fill the holes in the form-member. As such, the coated layer is physically more firmly combined with a form-member.

Further, the manufacturing method of the present invention can perform heat treatment in a mold after ejecting a powder type of organic fiber to the inside and outside a form-member, using compressed air. According to various embodiments, resin for accelerating hardening of the organic fiber can be selectively used (in accordance with the design conditions and the manufacturing specification). Further, it is possible to form a coated layer in a selected area of a form-member by partial heat treatment or partial ejection of organic fiber.

The specification and the embodiments shown in the drawings provide specific examples for helping understanding of the present invention, without limiting the scope of the present invention. It is apparent to those skilled in the art that the present invention may be modified in various ways on the basis of the spirit of the present invention other than the embodiments described herein.

What is claimed is:

1. A composite form-member comprising:
a hollow form-member formed of metal, the hollow form-member having an inner surface and an outer surface, and a plurality of holes formed through the inner and outer surface; and
a coated layer filling the holes and laminated on the inner and outer surfaces of the form-member, the coated layer formed of an organic fiber material with carbon.

2. The composite form-member of claim 1, further comprising a welding portion at an end portion of the form-member, the welding portion comprising an outer surface portion exposed without the coated layer laminated thereon.

3. The form-member of claim 1, wherein the form-member is cylindrical in shape and the holes are arranged in rows at predetermined distances around the form-member.

4. The form-member of claim 2, wherein the form-member is cylindrical in shape and the holes are arranged in rows at predetermined distances around the form-member.

5. The composite form-member of claim 1, wherein the form-member further comprises one end portion partially coated with the coated layer.

6. A method of manufacturing a composite form-member, the method comprising:
seating a hollow form-member having an inner surface and an outer surface, and a plurality of holes formed through the inner and the outer surface, in between an upper die and a lower die, and then inserting a core into the hollow form-member;
ejecting an organic fiber material containing carbon together with compressed air through nozzle pipes formed in the upper die, the lower die, and the core, to the inner surface and the outer surface of the form-member to fill the holes; and
forming a coated layer by heating the organic fiber material ejected on the inner and outer surfaces of the form-member such that the organic fiber material is carbonized.

7. The method of claim 6, wherein the organic fiber material is partially ejected such that the coated layer is not formed at one end portion of the form-member.

8. The method of claim 6, wherein the heat is partially applied from the upper die and the lower die such that the coated layer is not formed at one end portion of the form-member.

9. The method of claim 6, wherein the form-member further comprises one end portion partially coated with the coated layer.

10. The method of claim 6, wherein the form-member is cylindrical in shape and the holes are arranged in rows at predetermined distances around the form-member.

11. The method of claim 7, wherein the form-member is cylindrical in shape and the holes are arranged in rows at predetermined distances around the form-member.
